(19) United States
(12) Patent Application Publication
(10) Pub. No.: US 2026/0371062 A1
(43) Pub. Date: Nov. 19, 2026

(54) TECHNIQUES FOR USER EQUIPMENT MEMORY MANAGEMENT IN WIRELESS COMMUNICATIONS

(71) Applicant: QUALCOMM Incorporated, San Diego, CA (US)

(72) Inventors: Tommy AZZINO, Jersey City, NJ (US); Navid ABEDINI, Basking Ridge, NJ (US); Jelena DAMNJANOVIC, Del Mar, CA (US); Tao LUO, San Diego, CA (US); Junyi LI, Greentown, PA (US)

(21) Appl. No.: 19/655,602

(22) Filed: Apr. 22, 2026

Related U.S. Application Data
(60) Provisional application No. 63/807,522, filed on May 16, 2025.

(51) Int. Cl. H04W 8/18; H04L 5/00; H04W 8/22; H04W 76/20

(52) U.S. Cl. CPC H04W 8/183; H04L 5/0053; H04W 8/22; H04W 76/20

(57) ABSTRACT

This disclosure provides methods, components, devices and systems for techniques for wireless device memory management in wireless communications. For example, a first wireless device, such as a user equipment (UE) or a network entity, may transmit one or more memory status reports, and another wireless device, such as another UE or network entity, can provide an indication to the first wireless device to start fetching or applying certain information or data from its memory. The first wireless device further may report a status of certain information or data, such as whether certain information is cached or decoded, associated memory retrieval times, and the like. The first wireless device further may report a status of stored information, the time it takes to retrieve or apply certain information, or both.

### CROSS REFERENCE

The present Application for Patent claims the benefit of U.S. Provisional Patent Application No. 63/807,522 by Azzino et al., entitled “TECHNIQUES FOR USER EQUIPMENT MEMORY MANAGEMENT IN WIRELESS COMMUNICATIONS,” filed May 16, 2025, assigned to the assignee hereof, and expressly incorporated by reference herein.

### TECHNICAL FIELD

This disclosure relates generally to wireless communication, and more specifically to systems, devices, methods, and techniques associated with techniques for user equipment memory management in wireless communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:
A method for wireless communications by a first wireless device is described. The method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof, receiving signaling from the second wireless device that indicates information is to be stored at the first wireless device, and transmitting one or more of a report that indicates a status of memory storage at the first wireless device or an inquiry for information that can be removed from the memory storage at the first wireless device.
A first wireless device for wireless communications is described. The first wireless device may include a processing system that includes processor circuitry and memory circuitry that stores code. The processing system may be configured to cause the first wireless device to transmit an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof, receive signaling from the second wireless device that indicates information is to be stored at the first wireless device, and transmit one or more of a report that indicates a status of memory storage at the first wireless device or an inquiry for information that can be removed from the memory storage at the first wireless device.
Another first wireless device for wireless communications is described. The first wireless device may include means for transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof, means for receiving signaling from the second wireless device that indicates information is to be stored at the first wireless device, and means for transmitting one or more of a report that indicates a status of memory storage at the first wireless device or an inquiry for information that can be removed from the memory storage at the first wireless device.
A non-transitory computer-readable medium storing code for wireless communications is described. The code may include instructions executable by one or more processors to transmit an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof, receive signaling from the second wireless device that indicates information is to be stored at the first wireless device, and transmit one or more of a report that indicates a status of memory storage at the first wireless device or an inquiry for information that can be removed from the memory storage at the first wireless device.

In some examples of the method, first wireless devices, and non-transitory computer-readable medium described herein, the information stored at the first wireless device includes one or more RRC profiles, one or more artificial intelligence of machine learning models, one or more measurements obtained at the first wireless device, one or more configurations for wireless communications at the first wireless device, relay information for relaying information between the second wireless device and one or more other wireless devices, sensing information, memory-as-a-service information, digital twin information or any combination thereof.

In some examples of the method, first wireless devices, and non-transitory computer-readable medium described herein, the indication of the memory capability includes one or more amounts of storage available for storing information received from one or more other wireless devices, one or more amounts of storage available for storing one or more types of information, or any combination thereof. In some examples of the method, first wireless devices, and non-transitory computer-readable medium described herein, the indication of the memory capability includes a quantity of bytes available for storage for one or more types of data, an indication of a percentage of a total storage capacity that may be available for one or more types of data, or an indication of a quantized range of available storage capacity for the one or more types of information.

In some examples of the method, first wireless devices, and non-transitory computer-readable medium described herein, the inquiry for information that can be removed may be transmitted responsive to a remaining quantity of bytes available for storage being less than a threshold value or less than a quantity of storage associated with an upcoming action. In some examples of the method, first wireless devices, and non-transitory computer-readable medium described herein, the inquiry for information that can be removed includes a list of indicators of stored information that are candidates for removal.

Some examples of the method, first wireless devices, and non-transitory computer-readable medium described herein may further include operations, features, means, or instructions for transmitting, responsive to removing at least a portion of stored information, a report of removed information, where the removed information may be identified based on a response from the second wireless device that indicates information to be removed, one or more rules for identifying information to be removed, or any combination thereof. In some examples of the method, first wireless devices, and non-transitory computer-readable medium described herein, the indication of the memory capability includes one or more of a quantity of information that can be stored at the first wireless device, a per-item size limit for information to be stored, a retrieval time or latency for stored information, a time duration for storing information, a validity time duration for stored information, one or more time periods during which storage are available, retrieval time as a function of an amount of information stored at the memory storage at the first wireless device, or any combination thereof.

In some examples of the method, first wireless devices, and non-transitory computer-readable medium described herein, the indication of the memory capability may be provided for two or more different configurations of the first wireless device, each configuration based on a state of the first wireless device, a type of information that is stored, or both, and where the state of the first wireless device may be an idle-mode state, an inactive-mode state, or a connected-mode state. In some examples of the method, first wireless devices, and non-transitory computer-readable medium described herein, the report may be transmitted according to a periodic schedule or detection of a trigger event. Some examples of the method, first wireless devices, and non-transitory computer-readable medium described herein may further include operations, features, means, or instructions for receiving a request for one or more of an indication of whether storage is available, an indication of whether a particular type or size of information can be stored, or an indication of whether a certain quantity of information can be stored, and where the report may be transmitted responsive to the request.

Some examples of the method, first wireless devices, and non-transitory computer-readable medium described herein may further include operations, features, means, or instructions for removing at least a portion of information from the memory storage based on one or more of a response to the inquiry for information that can be removed from the memory storage, one or more rules for information removal, or a connected, active, or idle status of the first wireless device. Some examples of the method, first wireless devices, and non-transitory computer-readable medium described herein may further include operations, features, means, or instructions for receiving an indication to remove at least a first portion of information from the memory storage prior to transmitting one or more of the report that indicates the status of memory storage at the first wireless device or the inquiry for information that can be removed from the memory storage.

Some examples of the method, first wireless devices, and non-transitory computer-readable medium described herein may further include operations, features, means, or instructions for receiving signaling to initiate retrieval of at least a first portion of information from the memory storage, where the signaling includes a parameter for retrieval of the first portion of information and transmitting an acknowledgment that indicates the first portion of information has been retrieved from the memory storage or that indicates a time at which the first portion of information will be available for processing, in accordance with the parameter for retrieval of the first portion of information. In some examples of the method, first wireless devices, and non-transitory computer-readable medium described herein, the parameter for retrieval of the first portion of information includes one or more conditions to trigger the retrieval of the first portion of information. In some examples of the method, first wireless devices, and non-transitory computer-readable medium described herein, the acknowledgment may be transmitted when the first wireless device is able to support retrieval of the first portion of information in accordance with the parameter, and where a negative acknowledgment is transmitted otherwise.

Some examples of the method, first wireless devices, and non-transitory computer-readable medium described herein may further include operations, features, means, or instructions for receiving information to be stored from the second wireless device, where the first wireless device and the second wireless device provide assistance to each other for storing or retrieving information pertaining to one or more RRC profiles, one or more artificial intelligence of machine learning models, one or more measurements obtained at the first wireless device or the second wireless device, one or more configurations for wireless communications at the first wireless device or the second wireless device, relay information for relaying information between the second wireless device and one or more other wireless devices, sensing information, memory-as-a-service information, digital twin information or any combination thereof.

Some examples of the method, first wireless devices, and non-transitory computer-readable medium described herein may further include operations, features, means, or instructions for receiving a request to reserve at least a portion of the memory storage for storing information in accordance with signaling from the second wireless device, and where the indication of the memory capability further indicates whether at least the portion of the memory storage is available for storing information. Some examples of the method, first wireless devices, and non-transitory computer-readable medium described herein may further include operations, features, means, or instructions for exchanging signaling with the second wireless device to coordinate a resolution or a quality of the information, or both, to be stored at the first wireless device.

Some examples of the method, first wireless devices, and non-transitory computer-readable medium described herein may further include operations, features, means, or instructions for obtaining information to be stored in the memory storage at the first wireless device, storing the information in the memory storage, performing an integrity check on the information in the memory storage, and transmitting an indication of corrupted information when the integrity check fails.

### BRIEF DESCRIPTION OF THE DRAWINGS

FIG. 1 shows an example of a wireless communication system.

FIG. 2 shows an example of a signaling configuration that supports techniques for user equipment (UE) memory management in wireless communications.

FIG. 3 shows an example of a process flow that supports techniques for UE memory management in wireless communications.

FIG. 4 shows a block diagram of a processing system that supports techniques for UE memory management in wireless communications.

FIG. 5 shows a diagram of a system including a UE that supports techniques for UE memory management in wireless communications in accordance with one or more aspects of the present disclosure.

FIG. 6 shows a diagram of a system including a network entity that supports techniques for UE memory management in wireless communications in accordance with one or more aspects of the present disclosure.

FIGS. 7 - 12 show flowcharts illustrating methods that support techniques for UE memory management in wireless communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate with one or more network entities (e.g., radio heads, gNodeBs, and the like), one or more other UEs (e.g., via sidelink or PC5 communications, Bluetooth communications, Wi-Fi communications, and the like). In some cases, various parameters and configurations may be stored at the UE that support communications. In some cases, a UE may have access to relatively limited storage (e.g., memory available for storage of information related to communications with one or more network entities or other UEs). For example, a UE may use its memory for storing various communication-related info (e.g., its static configurations, capabilities, network-related configurations, measurements, processing data, etc.). In some emerging use cases a UE’s memory (e.g., storage capability/capacity) can be further used or leveraged, such as for compute services or relaying operations, for example. In order to provide for efficient provisioning of functions of a UE, it may be beneficial for a network entity, or other wireless device (e.g., another UE) to be aware of a UE’s memory-related capabilities, its updated status, and a framework to efficiently manage the UE, which could be use-case-specific.

Aspects of the subject matter described in this disclosure relate to UE indication of a memory capability or status, or both. For example, a UE may transmit one or more memory status reports that may be used for dynamic memory status reporting, and a network entity or other entities (e.g., another UE) can provide an indication to the UE to start fetching or applying certain information or data (e.g., radio resource control (RRC) profiles, artificial intelligence (AI) or machine learning (ML) models, measurements, configurations, relay information, etc.) from its memory. In some aspects, a UE may report the status of certain information or data (e.g., RRC profiles, AI/ML models, measurements, configurations, relay info, etc.), such as whether certain information is cached or not, decoded or not, associated memory retrieval times, and the like. In some aspects, if the UE has a relatively small amount of available storage, a network entity (or other wireless device) may exchange information to assist deciding which stored information may be removed from storage at the UE. Additionally, or alternatively, a UE may report a status of stored information, the time it takes to retrieve or apply certain information (e.g., data, files, or other information), or both. Additionally, or alternatively, two or more UEs may provide assistance to each other for storing or retrieving information pertaining certain configurations, services, features, use-cases, and the like.

Particular aspects of the subject matter described in this disclosure can be implemented to realize one or more of the following potential advantages. In some examples, by providing a UE memory capability or status, the described techniques can be used to allow a UE to retrieve and apply certain information through an indication from another wireless device (e.g., a proactive indication), which may reduce latency associated with retrieval or application of the information. In some examples, by providing a report of the status of certain information or data of a UE, a network entity or other wireless device may determine one or more actions in accordance with the status, allowing for more efficient usage of the information or data in accordance with the status. Additionally, or alternatively, by providing that two or more UEs may assist each other for storing or retrieving information, the described techniques may provide storage sharing and reduced latency for accessing stored information. Various techniques as discussed herein may thus enhance management decisions at a network entity or other UE, enable new use-cases and services, or both.

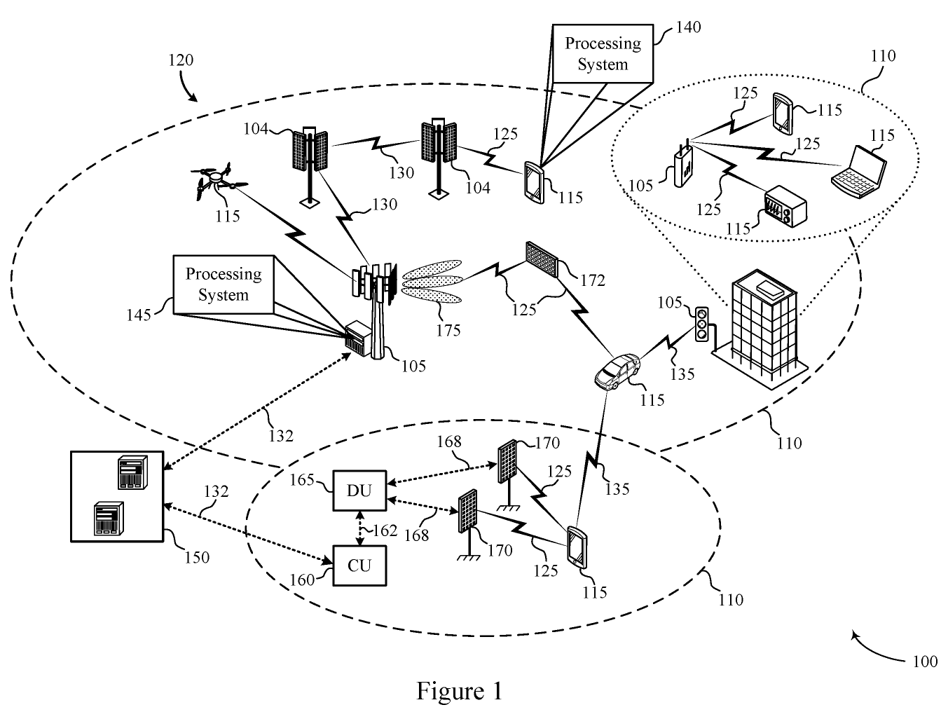

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for techniques for UE memory management in wireless communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support indications of a UE memory capability or status, which may allow a UE to store information, and then retrieve and apply such information through an indication from another wireless device (e.g., a proactive indication), which may reduce latency associated with retrieval or application of the information.

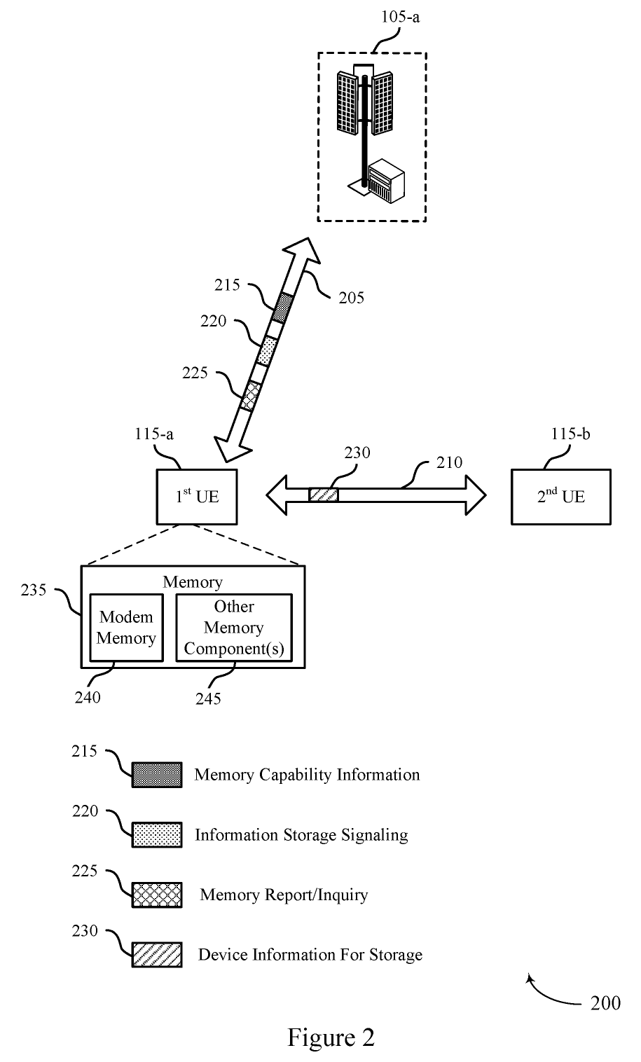

FIG. 2 shows an example of a signaling configuration 200 that supports techniques for UE memory management in wireless communications. In some examples, signaling configuration 200 may implement aspects of wireless communications system 100. In the example of FIG. 2, signaling configuration 200 may include a network entity 105-a, a first UE 115-a, and a second UE 115-b. The network entity 105-a, first UE 115-a, and second UE 115-b may be examples of the corresponding devices described with respect to FIG. 1.

In accordance with various aspects, the first UE 115-a (which may be an example of a first wireless device), may establish a first link with the network entity 105-a (which may be an example of a second wireless device) via a first connection 205 (e.g., a connection via a Uu interface). In some examples, the first UE 115-a may establish a second link with the second UE 115-b via a second connection 210 (e.g., a connection via a sidelink or PC5 interface, a Bluetooth interface, a Wi-Fi interface, etc.). In some examples, as discussed herein, the first UE 115-a may transmit memory capability information 215 to the network entity 105-a. The network entity 105-a may receive the memory capability information 215 may be transmit information storage signaling 220 to the first UE 115-a. In some aspects, the first UE 115-a may transmit a memory report or inquiry 225, which may provide a status of storage at the first UE 115-a, provide an inquiry for whether one or more portions of stored information (e.g., files, RRC configurations, etc.) may be removed from storage at the first UE 115-a. In some examples, such as illustrated in FIG. 2, the first UE 115-a may exchange device information for storage 230 with the second UE 115-b, such as in cases where a group of cooperating UEs 115 may provide assistance to UEs 115 within the group.

In some aspects, the first UE 115-a may include memory 235, which may be formed of memory from multiple components of the first UE 115-a, including a modem memory 240 (e.g., a volatile and/or non-volatile memory of a wireless communications modem that supports 5G or 6G communications) and one or more other memory components 245 (e.g., volatile and/or non-volatile memory available for an operating system of the first UE 115-a). In some aspects, the first UE 115-a can use, based on its implementation, volatile memory (such as RAM) to store any network-related parameters temporarily while managing the connection. This memory is used for handling dynamic tasks like maintaining RRC states (e.g., RRC_IDLE, RRC_INACTIVE, RRC_CONNECTED) and processing signaling information, for example. Additionally, non-volatile memory (such as flash storage) may be used to store more persistent data, including configuration settings and security keys. This ensures that such persistent information is retained even when the device is powered off. For example, volatile memory may provide for data retention and may store data temporarily, and the data is lost when power is turned off to the memory. Volatile memory is often faster than non-volatile memory, allowing relatively quick access and processing, and is often used for active processes and tasks, such as running applications and handling dynamic data. Volatile memory may have a smaller storage capacity than non-volatile memory. Non-volatile memory may store data in a persistent manner, such that data is retained even when power is turned off to the memory. Non-volatile memory may have relatively slower read and write speeds compared to volatile memory, and may be used for storing persistent data, such as system settings, files, and security keys. Non-volatile memory may have a larger storage capacity than volatile memory.

In some aspects, the first UE 115-a may use its memory 235 to store information that is for example related, but not limited, to: sensing information or data (e.g., logged information or data) from sensing-related measurements of the first UE 115-a; one or multiple radio resource control (RRC) profiles or network-related configurations like RRC configurations that may not be immediately used or activated; relaying or repeating operations (e.g., to store the received data to be further relayed or forwarded to another network node); UE collaboration (e.g., as in relaying/repeating operation, and/or for storing or processing at least part of uplink or downlink signals, measurements, or configurations of another UE); lending memory to other devices to store their information (e.g., data can be for any possible use-case such as for AI/ML-related features for collecting and storing training data, or storing some models, etc.); digital twin information of a certain tracking area (TA) or region or location (e.g., that may be used for maintaining or fine-tuning the digital twin, or using digital twin to enhance some other procedures), or any combination thereof. Further, the memory 235 may be used to store information for the following: logged (e.g., idle-mode) measurements on serving or neighbor cell(s) (e.g., for the purpose of cell search or cell selection or handover, minimization of drive test (MDT) information, data collection, training, or any combination thereof); configuration parameters and security information from the network entity 105-a, device capabilities (e.g., supported frequency bands, hardware features, etc.); service usage data (e.g., data consumption, call records, session durations, etc.); or any combination thereof.

In some aspects, the first UE 115-a may have relatively limited storage availability (e.g., in particular for its volatile or relatively fast memory), and memory reporting techniques as discussed herein may inform other wireless devices, such as network entity 105-a or a different UE, of the relatively limited or available storage capabilities of the first UE 115-a. Moreover, as discussed, the first UE 115-a may have different types of memory (or different methods for storing data – such as memory ports to use for different type of memory), including volatile memory (e.g., random access memory (RAM)) to store limited amounts of data that may have faster access, and non-volatile memory (e.g., flash storage) to store more persistent data but with longer retrieval latency. When the first UE 115-a is to store and retrieve information to or from memory 235, the type of memory where the information is stored or retrieved (e.g., fast volatile vs. slow non-volatile) may become a relevant factor that can influence storage and retrieval times, and hence UE 115-a performance. For example, if delay-sensitive RRC parameters belonging to a certain RRC profile configuration are not stored via fast-accessible memory, then retrieval latency can increase latency of configuration for the first UE 115-a.

In accordance with some aspects discussed herein, the first UE 115-a may use the memory capability information to indicate available memory for storing information (e.g., RRC profiles, AI/ML models, measurements, configurations, relay information, etc.), to report (e.g., dynamically) on the status of memory 235, and send memory report or inquiry 225 to the network entity 105-a that inquires which stored information can be removed in case the memory 235 is full or approaching being full. In some aspects, there may be multiple services, features, or use-cases, and semi-static or dynamic sharing of the memory across them. In some aspects, as discussed, the first UE 115-a may indicate the available memory for storing information. In some examples, the first UE 115-a may report multiple values (e.g., for each service, feature, or use case, etc.), and the network entity may provide an indication of how to split or partition the memory 235 for various services, features, or use-cases. In some cases, the first UE 115-a may suggest the split or partition in the memory capability information 215 or in a memory status report provided with memory report or inquiry 225. In some aspects, the indication may be a capability indication (e.g., part of the UE capabilities reported in one or more capability information messages transmitted via RRC signaling to the network entity 105-a). In some aspects, the indication may be in the form of a memory status report that can be periodic, event-triggered, or requested by the network entity 105-a. In some aspects, when indicating a memory split across different features, services, or use-cases, or a memory split for different files or configurations, the first UE 115-a may report a specific quantity of bytes, a percentage value of available storage, or an abstract value that indicates a particular range of a set of configured ranges.

In some aspects, if the first UE 115-a has exhausted, or is approaching exhaustion (e.g., the remaining available memory 235 is less than a threshold value or less than what is associated with an upcoming action), the memory 235 for storing relevant information, the first UE 115-a may send an inquiry the network entity 105-a (or another wireless device, such as another UE) for an identification of information data that can be removed. In some aspects, the first UE 115-a may provide a list of indicators (e.g., configuration IDs, file IDs, etc.) that are candidates for being removed, and the network entity 105-a may indicate which previously configured information (it is noted that the terms information, data, and files, may be used interchangeable herein) can be removed. Further, in some aspects, the first UE 115-a may report what is removed or to be removed, and the network entity 105-a may respond with an acknowledgment or stop indication. Additionally, or alternatively, the first UE 115-a may use a set of rules for removing information, such as based on a type of information (e.g., RRC profile configuration vs. measurements vs. relay information), a priority of the information, a timestamp of the information, a last activation or retrieval time, among others.

In some aspects, to allow for efficient usage of the memory 235 at the first UE 115-a, the first UE 115-a may indicate to the network entity 105-a its memory capabilities. In some cases, this can be a memory capability indication provided when the first UE 115-a connects to the network entity 105-a (e.g., part of the memory capability information 215 that may be provided semi-statically). In some examples, this indication may include a maximum number of files or information the first UE 115-a can store, a maximum number of bytes of information that can be stored, or both. Further, in some cases a per-file or information size limitation (e.g., in bytes) may be provided by the first UE 115-a. Additionally, or alternatively, the first UE 115-a may include an indication for the retrieval time or latency of certain information from memory 235, which may be one latency value for all the information stored (e.g., an average or maximum retrieval time or other stats such as an X^{th} percentile), or a range of retrieval latency (min-max) for the information stored.

In some examples, the first UE 115-a may also indicate retrieval latency as a function of the file size (e.g., in bytes), the number of files or information, the current amount of memory used (e.g., if the memory 235 is almost full, the retrieval time may increase), or any combination thereof. For example, the first UE 115-a may indicate a list of retrieval times as a function of the amount of memory used, or percentiles (e.g., retrieval time X if the memory 235 is used within 20% of its capacity, retrieval time Y if the memory 235 is at 80% if its capacity, etc.). In some cases, the first UE 115-a may include a time duration for storing certain information. Further, there may also be a validity time duration for the shared storage information (e.g., the network entity 105-a may assume the first UE 115-a has the reported available storage for a configured or indicated time duration T). Further, the first UE 115-a may also include ON/OFF cycle information, and during an ON time (e.g., with duration M secs) the first UE 115-a is available for storing information, while during an OFF time (e.g., with duration S secs) the first UE 115-a is not available for storing information.

The various memory parameters may be generic-configured parameters or may be indicated specifically for multiple different configurations based on a status of the first UE 115-a (e.g., different memory configurations based on whether the first UE 115-a is in an idle, inactive, or connected mode). For example, the first UE 115-a in an idle mode may have reduced (e.g., for energy savings purposes), or increased (e.g., due to using less memory for communication-related info) memory capabilities compared to the first UE 115-a in connected mode. In other aspects, additionally or alternatively, multiple configurations may be provided based on the type of information or use cases that can be stored (e.g., RRC profiles, AI/ML models, measurements, configurations, relay info, etc.). In some aspects, these parameters may not be fixed (e.g., communicated as UE capabilities) but may change dynamically based on a current status or condition of the first UE 115-a.

In some aspects, the first UE 115-a may want to report to the network entity 105-a the status of memory 235. For example, if the memory 235 is almost all exhausted then the first UE 115-a may report it to the network entity 105-a in one or more memory reports provided with memory report or inquiry 225 communications. In some aspects, a memory status report can be periodic, and the network entity 105-a may configure a memory status report configuration to indicate to the first UE 115-a a periodicity of the reports, the information to include in each report, and the resources to use for each report. A report configuration may be generic or UE-status specific (e.g., idle, inactive, or connected mode), or specific to a type of information that can be stored or retrieved (e.g., RRC profiles, AI/ML models, measurements, configurations, relay info, etc.). In some aspects, a memory status report can be event-triggered, and there may be events for which the first UE 115-a may be triggered to report its memory status. For example, the first UE 115-a may have reached 90% of consumed memory and may report this to the network entity 105-a. In another example, the first UE 115-a may have freed some storage and may communicate to the network entity 105-a that it has available memory for storing new information. In some cases, events may be associated to the first UE 115-a status (e.g., idle, inactive, connected mode) or to the type of information (e.g., RRC profiles, AI/ML models,/measurements, etc.)

In some aspects, a memory status report can be requested by the network entity 105-a. For example, the network entity 105-a may simply ask whether the first UE 115-a has available memory or not. In another example, the network entity 105-a may ask whether the first UE 115-a has enough memory for a specific use-case, feature, AIML model, RRC configuration, profile, etc. In still another example, the network entity 105-a may ask whether the first UE 115-a has enough memory to store N bytes. In some aspects, having the network entity 105-a inquiring the first UE 115-a for memory status reports can save overhead associated with periodic or event-based reporting. In some cases, a report configuration or triggering event can be UE-specific (e.g., indicated to the first UE 115-a through dedicated RRC signaling) or semi-statically configured (e.g., in system information block (SIB) or system information (SI)) or defined in a communications specification.

In some aspects, a memory status report may contain the available memory at the first UE 115-a in different ways. For example, a memory status report may contain an explicit indication on the actual available memory (e.g., X MBytes or GBytes), or may have multiple ranges of values (e.g., uniform or non-uniform) configured and the first UE 115-a indicates an index value mapped to the relevant range. For example, ranges can be communicated through a memory status report configuration. In some examples, the first UE 115-a may indicate its available memory as a percentage. In other examples, the indication can be an abstract value within some range (e.g., 0 to 1000), and the communicating devices may coordinate on how to interpret a value within this range. Further, as discussed herein, a memory status report may also be used for adaptation (e.g., dynamic adaptation) of ON/OFF memory cycles (e.g., during ON time the first UE 115-a is available for storing information, while during OFF time the first UE 115-a is not available).

In some aspects, as discussed, when there is not enough memory available for the first UE 115-a, or other conditions or events may have occurred, the first UE 115-a may transmit a request to the network entity 105-a for what information should be deleted or removed in order to free some of its memory. In some examples, the first UE 115-a may send an inquiry to the network entity 105-a asking which information can be removed (e.g., share the list of profiles IDs and possibly their version IDs/timestamps). In some cases, the network entity 105-a may indicate removing some of the previously configured information. The indication may be, for example, via dedicated RRC or lower-layer signaling. Further, this indication may or may not be in response to the first UE 115-a inquiry (e.g., may be in response to a memory status report from the first UE 115-a). Additionally, or alternatively, there may be rules for removing information. For example, removal of information may be based on indicated priorities, timestamps, last time the information was activated or retrieved, information that is not currently used, or a prediction on whether certain information may or may not be used in near future. In some cases, removal of information may be based on the first UE 115-a status (e.g., idle/inactive/connected) or the type of information that can be removed (e.g., RRC profiles, AI/ML models, measurements, digital-twin, etc.). For example, the first UE 115-a or network entity 105-a may prefer to remove digital-twin data rather than RRC parameter configurations. This can be left to the first UE 115-a, and/or assisted or configured by the network entity 105-a, or provided in a communications specification. In some examples, the first UE 115-a may or may not reply with an acknowledgment (ACK) or negative acknowledgment (NACK), or indication of what information has been removed.

In some aspects, the network entity 105-a may have knowledge of the information that the first UE 115-a can store or retrieve, and may want to provide an early indication to the first UE 115-a to start fetching or applying certain information for upcoming usage (e.g., RRC profiles, AI/ML models, measurements, configurations, relay info, etc.). In some cases, the network entity 105-a may send an indication that to the first UE 115-a to start fetching from its memory 235 and begin interpreting or decoding certain information for upcoming use. In some cases, one or more time attributes (such as time-to-fetch, time-to-execute) can also be indicated to the first UE 115-a. In some examples, the first UE 115-a may send back a ‘ready’ or ‘ready-within-a-certain-time’ indication as a response. When some information is provided to the first UE 115-a, the network entity 105-a may indicate to decode part or all of the provided information immediately if some or all parts are to be used. In some aspects, the network entity 105-a may also prompt the first UE 115-a to delete stored data that is no longer needed, before the first UE 115-a checks with network entity 105-a when it is running out of the memory. In some aspects, an early indication may be given in the form of conditions, and the first UE 115-a may fetch, retrieve, or decode certain information when one or more certain conditions are met.

In some aspects, the network entity 105-a may send an indication that the first UE 115-a should start retrieving and/or decoding or applying certain information for upcoming use. Such an indication from the network entity 105-a can be proactive (e.g., an early indication). For example, if a certain RRC profile is to be used, then to reduce latency of configuration, the network entity 105-a can send an indication ahead of time. In some cases, an ahead-of-time indication may be based on retrieval time information that the UE indicated among its capabilities. For example, the network entity 105-a may be able to predict that the first UE 115-a needs to retrieve or apply certain information (e.g., using AI/ML). In some cases, the first UE 115-a may or may not reply to this indication. A first UE 115-a response may include, for example, a ‘ready’ indication to the network entity 105-a, or a ‘ready-within-Y-sec’ indication (in the case the first UE 115-a needs more time for retrieving and applying the information). In some cases, a NACK may be sent if the first UE 115-a is not able to fetch, apply, or decode the indicated information. In some cases, time attributes (e.g., time-to-fetch, etc.) may be also supported for this early indication (e.g., the network entity 105-a telling the first UE 115-a to be prepared to use that information within an indicated ‘time-to-fetch’).

In some aspects, techniques may provide for relatively fast retrieval of information that can be stored in different memories, based on the first UE 115-a implementation and capabilities. In some aspects, the first UE 115-a may report a status of stored information, a time it takes to retrieve or apply certain information, or both. In some aspects, the first UE 115-a may report a status of stored information (e.g., whether it is available for fast retrieval or not, decoded or not, etc.). In some examples, the first UE 115-a may indicate if information is cached or not (e.g., if it can be retrieved fast or not). For example, the first UE 115-a may choose between different memories to store different information, such as by using faster access memory (with reduced storage space) and a slower-access memory (with more storge). In some cases, the first UE 115-a may indicate if part or all of a certain file or information has already been decoded. In some cases, the first UE 115-a may indicate (e.g., dynamically) the time it needs to fetch or apply certain information, which may be useful for the network entity 105-a early indication as discussed herein.

In some aspects, the first UE 115-a may have a choice to store certain information in volatile memory (e.g., cache memory for faster access), or in non-volatile memory (e.g., that will take longer to fetch). In some cases, the first UE 115-a can report the status of stored information including, for example: whether the information is cached or not (that is, whether the first UE 115-a can retrieve it faster or not); whether the information are decoded or not and if not the time the first UE 115-a requires for decoding; and an indication of a time needed to fetch or apply certain information.

It is noted that several examples discussed herein are between a UE and network entity, and that these examples are provided for purposes of discussion and illustration. Techniques as discussed herein can be extended to different network entity couples (e.g., UE–UE, network entity–network entity, etc.). For example, two (or more) UEs can help each other and communicate with each other for the purpose of storing information for certain configuration, features, and/or use cases. In another example, it may be that two network entities are helping and communicating to perform storage functions over their backhaul connections.

In some aspects, different UEs 115 may collaborate, such as first UE 115-a and second UE 115-b. For example, in the context of UE collaboration, multiple UEs may be, at least temporarily, co-located (e.g., moving together in the same car, train, bus) and get help from each other to perform certain network procedures (e.g., random access channel (RACH), SI acquisition, cell selection/reselection). In some aspects, two or more UEs (e.g., within a collaboration group) can help each other with storing or retrieving information pertaining certain configurations, services, features, or use-cases, as discussed herein. In some cases, a subset or all UEs in a group may be elected as an ‘assisting UE’ (e.g., the UEs providing storage or retrieval capabilities), while ‘assisted UEs’ can get help from the assisting UEs. The group or a subgroup of assisting UEs can form a virtual memory (e.g., the aggregation of the memory capabilities of the assisting UEs), and a UE can have a local memory configuration and/or a group memory configuration (e.g., that can include an ID of the subset of UEs providing storage or retrieval capabilities). If a UE needs to retrieve information from another UE (e.g., an assisting UE) then the retrieval time in the case of collaboration may be increased. In this case, the ranges or values associated with the retrieval time may be adjusted accordingly. For example, in a group memory configuration, a ‘write latency’ parameter may be indicated that accounts for the writing of data to a certain storage that may be bottlenecked by the UE–UE communication interface. In some cases, the network entity 105-a may or may not be aware or allow collaboration between UEs to store information. In some examples, if the network entity 105-a is aware, it may set some constraints for the collaboration between UEs: For example, there may be a memory limit (e.g., in Mbytes) for the data to be stored by each UE, or it may impose a time constraint, an area or location constraint, or both, for the collaboration between UEs. The local communication between UEs can happen through any UE–UE communication technique, such as sidelink, Bluetooth, Wi-Fi, etc. In the case of network entity–network entity communication, the related entities may use, for example, backhaul messages or protocols.

In accordance with various techniques discussed herein, signaling between wireless devices may be used to exchange memory capabilities, memory configurations, and memory status reports, among other information. In some aspects, signals may be by the first UE 115-a and network entity 105-a may include any combination among layer one, layer two, and layer three (L1/L2/L3) messages or signals, such as one more medium access control (MAC) control elements (CEs), control channel communications (e.g., physical uplink control channel (PUCCH) or physical downlink control channel (PDCCH) communications), unicast communications, broadcast communications, multicast communications, one or more paging messages, dedicated RRC signaling, or any combination thereof. In some examples, some signaling can happen during a random access channel (RACH) procedure (e.g., memory capabilities exchange). Further, such communications may involve wake-up signal (WUS) transmissions (e.g., WUS, uplink WUS, low-power WUS, or low-power uplink WUS transmissions). Some memory configurations can be contained in SIB or SI, be specification-defined, or be pre-configured. In some examples, there may be an over-the-top (OTT) server or application handling the described memory procedures.

In some aspects, the network entity 105-a (or other entity) may ask the first UE 115-a (or other entity) to set aside a certain amount of memory for a certain task, service, feature, AI/ML-model, or profile. For example, the network entity 105-a (or other entity) may send a request to the first UE 115-a (or other entity) to reserve a certain portion of its memory for a certain task, service, feature, AI/ML model, profile, and the like. In one example, the network entity 105-a may request the first UE 115-a to reserve some memory for some RRC profiles. In another example, network entity 105-a may request the first UE 115-a to reserve memory for a new AI/ML model. In some cases, such as due to support for new features and use cases, the memory requirement of communication can increase and become more dynamic so that network entity 105-a may want to dynamically configure memory requirements. Such a request may avoid having a UE expose how its memory is used. In some cases, a UE (or other entity) may or may not reply with an ACK on the requested memory to reserve, or may reply with a NACK if the UE cannot reserve the requested memory. In some cases, if a NACK is indicated, the UE (or other entity) may indicate a cause (e.g., out-of-memory).

In some cases where the first UE 115-a (or other entity) has limited storage or memory issues, there may be a handshake with the network entity 105-a (or other entity) to establish a resolution for saving some information. For example, in the case of sensing data, the first UE 115-a and network entity 105-a can determine the quality or resolution of the associated sensing information. In some cases, the first UE 115-a (or other entity) can indicate that it can support multiple levels of resolution or quality for a certain application, feature, service, etc., and provide this indication semi-statically in its capabilities. In some examples, supported levels of resolution or quality may also change dynamically through a memory status report, as discussed. In some cases, the first UE 115-a can report the resolution or quality for certain stored information specifically. Alternatively, the network entity 105-a may give a range of resolution or quality, and the first UE 115-a can decide on the resolution or quality. In some cases, the network entity 105-a may provide some conditions, and the first UE 115-a may select resolution or quality accordingly. For example, if memory occupation is beyond X%, then reduce or select a lower resolution or quality.

In some aspects, cause values may be provided to indicate rejection or failure to retrieve or store any information. For example, if the first UE 115-a has exhausted its storage, then it can send an ‘out-of-memory’ to the network entity 105-a (or other entity). In the case of an ‘out-of-memory’ cause, the first UE 115-a (or other entity) may start dropping support for certain features, services, models, etc. In another example, the first UE 115-a may not be able to fetch or retrieve information and may send a ‘cannot find’ cause response to the network entity 105-a (or other entity). Or the first UE 115-a may not be able to apply a certain resolution or quality and may send a ‘resolution not applicable’ cause.

In some further aspects, memory-related triggering conditions may be used to take various actions, which may reduce the signaling overhead. Conditions can be associated with, for example, reading or writing latency/speed/rate, or can be use-case/feature/model/profile/etc.-specific. Actions may be associated with removing or fetching or caching/collecting/downloading/logging a certain information/data. For example, if the read speed goes beyond a certain threshold T, then the first UE 115-a (or other entity) may take the action of removing certain information. In another case, the available memory may exceed a threshold (e.g., X%) and the first UE 115-a (or other entity) may take the action of downloading a new profile/model/collect new sensing data/etc. In various aspects, reference is made to latency of retrieval, but similarly such aspects may be based on speed and/or rate of retrieval and associated signaling may provide speed and/or rate as metrics.

In some aspects, data corruption and integrity checks may be implemented when network entity 105-a stores information at the first UE 115-a, such as data on behalf of other entities (e.g., for the memory-as-a-service use case). For example, if the first UE 115-a is asked to retrieve something and the information is corrupted, the first UE 115-a (or other entity) can report it and add a cause value (e.g., "data/info is corrupted"). In other examples, if a client UE is retrieving information from a server UE and the information is corrupted, then it can send an indication to either the server UE or the network entity 105-a (or other entity) to report the information was corrupted.

In certain cases, the UE or network entity implementation may or may not allow borrowing memory from other sub-systems (e.g., modem memory is separated from system memory and modem cannot access system memory and vice versa). This may impact associated retrieval times for certain information or data. In some cases, similar to the case of UE collaboration where different UEs can share their memory for storage or retrieval, inter-module collaboration may be used. In such cases, an overall "virtual memory" can be associated to different sub-systems or modules. For example, in case of emergency, the wireless modem of a UE may borrow memory from Bluetooth and/or Wi-Fi subsystems. This may cause the other sub-systems to shut down and may add additional latency internal to the UE.

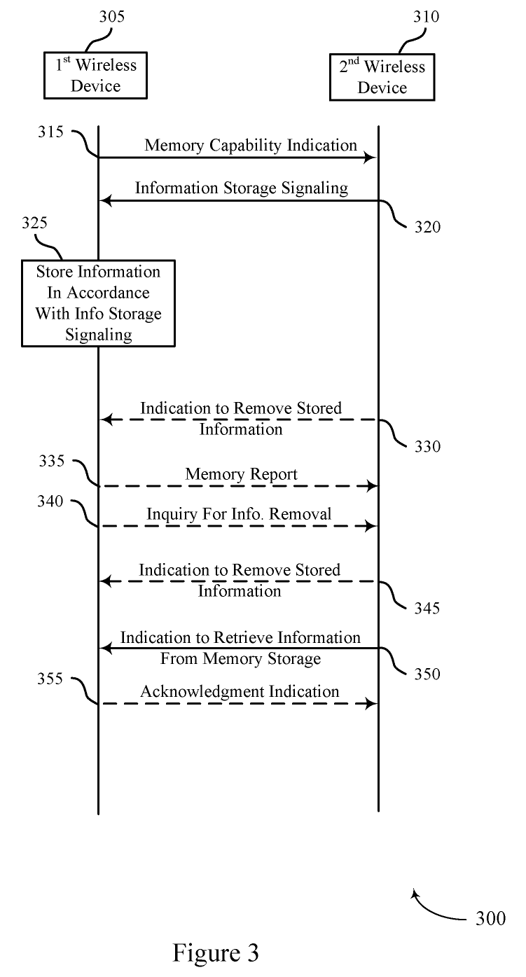

FIG. 3 shows an example of a process flow 300 that supports techniques for UE memory management in wireless communications. The process flow 300 may include a first wireless device 305 and a second wireless device 310, which may be examples of corresponding devices as described with reference to FIGS. 1 and 2. For example, the first wireless device 305 may be a UE or a network entity, and the second wireless device may be a UE or a network entity. In some cases, the process flow 300 may be implemented by the first wireless device 305 and the second wireless device 310 when memory capability information communications are configured and the first wireless device 305, the second wireless device 310, or both, indicates support for memory management as discussed herein. Such techniques may provide enhanced communications with more efficient configuration and operations based on an awareness of various memory-related parameters of the first wireless device 305, which may thereby enhance overall network efficiency, reduce power consumption, and enhance user experience. In the following description of the process flow 300, the operations between the first wireless device 305 and the second wireless device 310 may be performed in a different order than the example order shown. Some operations may be omitted from the process flow 300, and other operations may be added to the process flow 300.

At 315, the first wireless device 305 may transmit, and the second wireless device 310 may receive, a memory capability indication. In some cases, the memory capability indication may provide information related to an amount of storage available at the first wireless device 305, a latency associated with storage, timing associated with storage and retrieval of information, and the like, in accordance with techniques as discussed herein. In some examples, the memory capability indication may be transmitted via RRC signaling, one or more control channel transmissions, one or more MAC-CEs, or any combination thereof.

At 320, the second wireless device 310 may transmit, and the first wireless device 305 may receive, information storage signaling. The information storage signaling may indicate that the first wireless device 305 is to store information, in accordance with techniques as discussed herein. At 325, the first wireless device 305 may store information in accordance with the information storage signaling (e.g., may store one or more RRC configuration parameters, store one or more measurements, one or more sensor values, etc., as discussed herein).

Optionally, at 330, the second wireless device may transmit an indication to remove stored information, which may be received at the first wireless device 305. For example, the second wireless device 310 may preemptively indicate that the first wireless device 305 may remove information from storage prior to the first wireless device 305 transmitting an inquiry for removal of information, as discussed herein. In some cases, at 335, the first wireless device 305 may transmit, and the second wireless device 310 may receive, a memory report. The memory report may provide information related to a status of storage at the first wireless device 305, for example, as discussed herein. At 340, the first wireless device 305 may transmit, and the second wireless device 310 may receive, an inquiry for information removal. Such an inquiry may be transmitted in accordance with techniques as discussed herein. At 345, the second wireless device may transmit an indication to remove stored information, which may be received at the first wireless device 305. For example, one or more IDs associated with different portions of information, data, or files, may be identified for removal from storage at the first wireless device 305.

At 350, the second wireless device 310 may transmit, and the first wireless device 305 may receive, an indication to retrieve information from memory storage. Such an indication may be provided in accordance with techniques as discussed herein. At 355, optionally, the first wireless device 305 may transmit, and the second wireless device 310 may receive, an acknowledgement indication for the retrieval of information, in accordance with techniques as discussed herein.

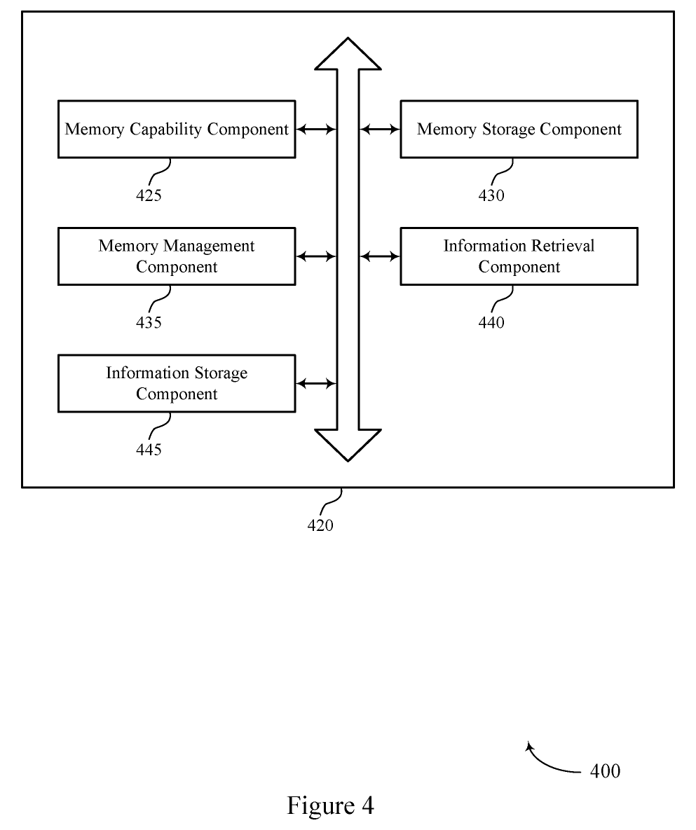

FIG. 4 shows an example 400 of a processing system 420 that supports techniques for UE memory management in wireless communications. A processing system 420 may be an example of a processing system 145 (such as network entity 105) and may include a memory capability component 425, a memory storage component 430, a memory management component 435, an information retrieval component 440, an information storage component 445, or any combination thereof. A processing system 420, or various component thereof, may be an example of means for performing (such as a means for causing a network entity 105 to perform) various techniques described herein.

The memory capability component 425 may be configured to cause the UE 115 or the network entity 105 to transmit an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. The memory storage component 430 may be configured to cause the UE 115 or the network entity 105 to receive signaling from the second wireless device that indicates information is to be stored at the first wireless device. The memory management component 435 may be configured to cause the UE 115 or the network entity 105 to transmit one or more of a report that indicates a status of memory storage at the first wireless device or an inquiry for information that can be removed from the memory storage at the first wireless device.

In some examples, the information stored at the first wireless device includes one or more RRC profiles, one or more artificial intelligence of machine learning models, one or more measurements obtained at the first wireless device, one or more configurations for wireless communications at the first wireless device, relay information for relaying information between the second wireless device and one or more other wireless devices, sensing information, memory-as-a-service information, digital twin information or any combination thereof. In some examples, the indication of the memory capability includes one or more amounts of storage available for storing information received from one or more other wireless devices, one or more amounts of storage available for storing one or more types of information, or any combination thereof. In some examples, the signaling from the second wireless device indicates two or more partitions for the memory storage at the first wireless device for two or more different types of information.

In some examples, the indication of the memory capability is transmitted based on a schedule or with a memory status report that is periodic, event-triggered, or requested by the second wireless device. In some examples, the indication of the memory capability includes a quantity of bytes available for storage for one or more types of data, an indication of a percentage of a total storage capacity that is available for one or more types of data, or an indication of a quantized range of available storage capacity for the one or more types of information. In some examples, the inquiry for information that can be removed may be transmitted responsive to a remaining quantity of bytes available for storage being less than a threshold value or less than a quantity of storage associated with an upcoming action. In some examples, the inquiry for information that can be removed includes a list of indicators of stored information that are candidates for removal. In some examples, the memory management component 435 may be configured to cause the UE 115 or the network entity 105 to transmit, responsive to removing at least a portion of stored information, a report of removed information, where the removed information is identified based on a response from the second wireless device that indicates information to be removed, one or more rules for identifying information to be removed, or any combination thereof.

In some examples, the indication of the memory capability includes one or more of a quantity of information that can be stored at the first wireless device, a per-item size limit for information to be stored, a retrieval time or latency for stored information, a time duration for storing information, a validity time duration for stored information, one or more time periods during which storage is available, retrieval time as a function of an amount of information stored at the memory storage at the first wireless device, or any combination thereof. In some examples, the indication of the memory capability is provided for two or more different configurations of the first wireless device, each configuration based on a state of the first wireless device, a type of information that is stored, or both, and where the state of the first wireless device is an idle-mode state, an inactive-mode state, or a connected-mode state. In some examples, the report is transmitted according to a periodic schedule or detection of a trigger event.

In some examples, the memory management component 435 may be configured to cause the UE 115 or the network entity 105 to receive a request for one or more of an indication of whether storage is available, an indication of whether a particular type or size of information can be stored, or an indication of whether a certain quantity of information can be stored, and where the report is transmitted responsive to the request. In some examples, the memory management component 435 may be configured to cause the UE 115 or the network entity 105 to remove at least a portion of information from the memory storage based on one or more of a response to the inquiry for information that can be removed from the memory storage, one or more rules for information removal, or a connected, active, or idle status of the first wireless device.

In some examples, the memory management component 435 may be configured to cause the UE 115 or the network entity 105 to receive an indication to remove at least a first portion of information from the memory storage prior to transmitting one or more of the report that indicates the status of memory storage at the first wireless device or the inquiry for information that can be removed from the memory storage.

In some examples, the information retrieval component 440 may be configured to cause the UE 115 or the network entity 105 to receive signaling to initiate retrieval of at least a first portion of information from the memory storage, where the signaling includes a parameter for retrieval of the first portion of information. In some examples, the information retrieval component 440 may be configured to cause the UE 115 or the network entity 105 to transmit an acknowledgment that indicates the first portion of information has been retrieved from the memory storage or that indicates a time at which the first portion of information will be available for processing, in accordance with the parameter for retrieval of the first portion of information. In some examples, the parameter for retrieval of the first portion of information includes one or more conditions to trigger the retrieval of the first portion of information. In some examples, the acknowledgment is transmitted when the first wireless device is able to support retrieval of the first portion of information in accordance with the parameter, and where a negative acknowledgment is transmitted otherwise.

In some examples, the report that indicates the status of memory storage includes one or more memory access speeds of one or more portions of the memory storage, an indication of information that has been retrieved from the memory storage, a time for accessing one or more portions of stored information, or any combination thereof.

In some examples, the memory management component 435 may be configured to cause the UE 115 or the network entity 105 to obtain information to be stored in the memory storage at the first wireless device. In some examples, the memory management component 435 may be configured to cause the UE 115 or the network entity 105 to select a first portion of the memory storage or a second portion of the memory storage for at least a first part of the information to be stored, the first portion of the memory storage having a faster access time than the second portion of the memory storage. In some examples, the memory management component 435 may be configured to cause the UE 115 or the network entity 105 to store at least the first part of the information to be stored in the first portion of the memory storage or the second portion of the memory storage.

In some examples, the first wireless device is a first UE or a first network entity, and the second wireless device is a second UE or a second network entity.

In some examples, the information storage component 445 may be configured to cause the UE 115 or the network entity 105 to receive information to be stored from the second wireless device, where the first wireless device and the second wireless device provide assistance to each other for storing or retrieving information pertaining to one or more RRC profiles, one or more artificial intelligence of machine learning models, one or more measurements obtained at the first wireless device or the second wireless device, one or more configurations for wireless communications at the first wireless device or the second wireless device, relay information for relaying information between the second wireless device and one or more other wireless devices, sensing information, memory-as-a-service information, digital twin information or any combination thereof.

In some examples, the first wireless device has one or more of a first memory configuration for local storage of the first wireless device, or a second memory configuration for storage of information from one or more other wireless devices. In some examples, the first wireless device and the second wireless device communicate via one or more MAC-CEs, control channel transmissions (e.g., PDCCH, PUCCH transmissions), unicast transmissions, broadcast transmissions, multicast transmissions, paging messages, RRC signaling, or any combinations thereof.

In some examples, the memory management component 435 may be configured to cause the UE 115 or the network entity 105 to receive a request to reserve at least a portion of the memory storage for storing information in accordance with signaling from the second wireless device, and where the indication of the memory capability further indicates whether at least the portion of the memory storage is available for storing information. In some examples, the memory management component 435 may be configured to cause the UE 115 or the network entity 105 to exchange signaling with the second wireless device to coordinate a resolution or a quality of the information, or both, to be stored at the first wireless device. In some examples, the memory capability component 425 may be configured to cause the UE 115 or the network entity 105 to transmit a message to the second wireless device that indicates a cause of unavailability of the memory storage at the first wireless device for further storage.

In some examples, the information storage component 445 may be configured to cause the UE 115 or the network entity 105 to obtain information to be stored in the memory storage at the first wireless device. In some examples, the information storage component 445 may be configured to cause the UE 115 or the network entity 105 to store the information in the memory storage. In some examples, the information storage component 445 may be configured to cause the UE 115 or the network entity 105 to perform an integrity check on the information in the memory storage. In some examples, the information storage component 445 may be configured to cause the UE 115 or the network entity 105 to transmit an indication of corrupted information when the integrity check fails.

In some examples, the memory storage at the first wireless device is associated with one or more components, and an amount of storage, retrieval times for obtaining stored information, or both are reported to the second wireless device based on the one or more components that provide the memory storage. In some examples, the indication of the memory capability indicates that the first wireless device supports one or more memory-related triggering conditions to take one or more actions, where the one or more memory-related triggering conditions include one or more of reading or writing latency, or one or more defined conditions for a use case, feature, model, or profile, and where the one or more actions include one or more of removing fetching, caching, collecting, downloading, or logging information.

By including or configuring a processing system 420 for operation in a processing system 420 as described herein, the processing system 420 may support techniques for indications of a UE memory capability or status, which may allow a UE to store information, and then retrieve and apply such information through an indication from another wireless device (e.g., a proactive indication), which may reduce latency associated with retrieval or application of the information.

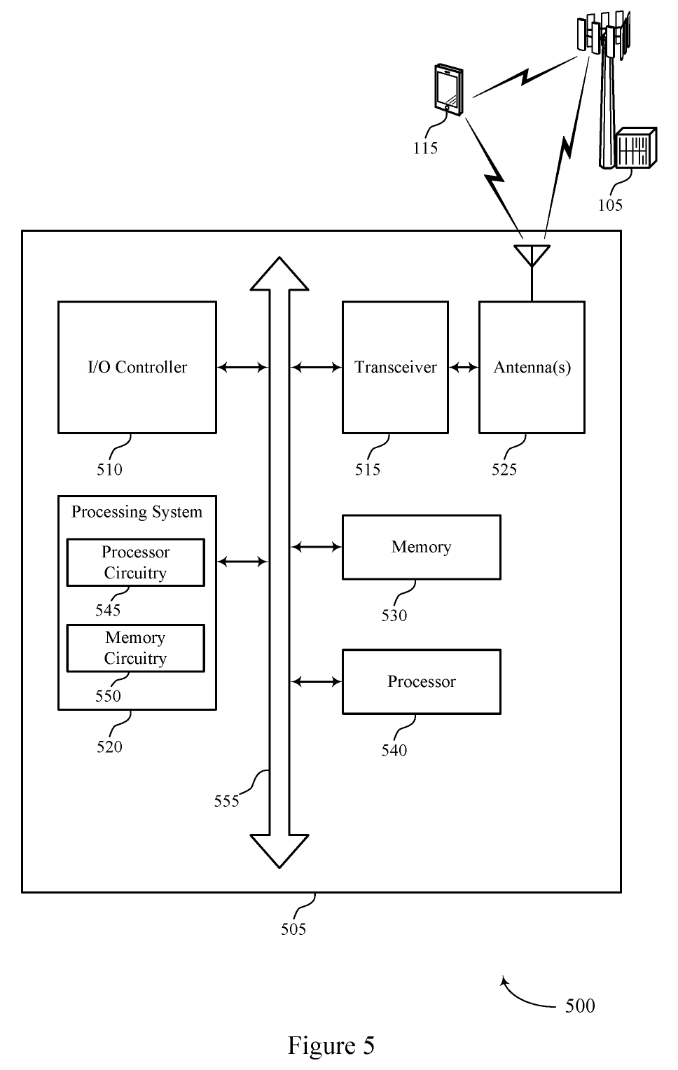

FIG. 5 shows an example of a system 500 including a device 505 that supports techniques for UE memory management in wireless communications. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support techniques for UE memory management in wireless communications. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for indications of a UE memory capability or status, which may allow a UE to store information, and then retrieve and apply such information through an indication from another wireless device (e.g., a proactive indication), which may reduce latency associated with retrieval or application of the information.

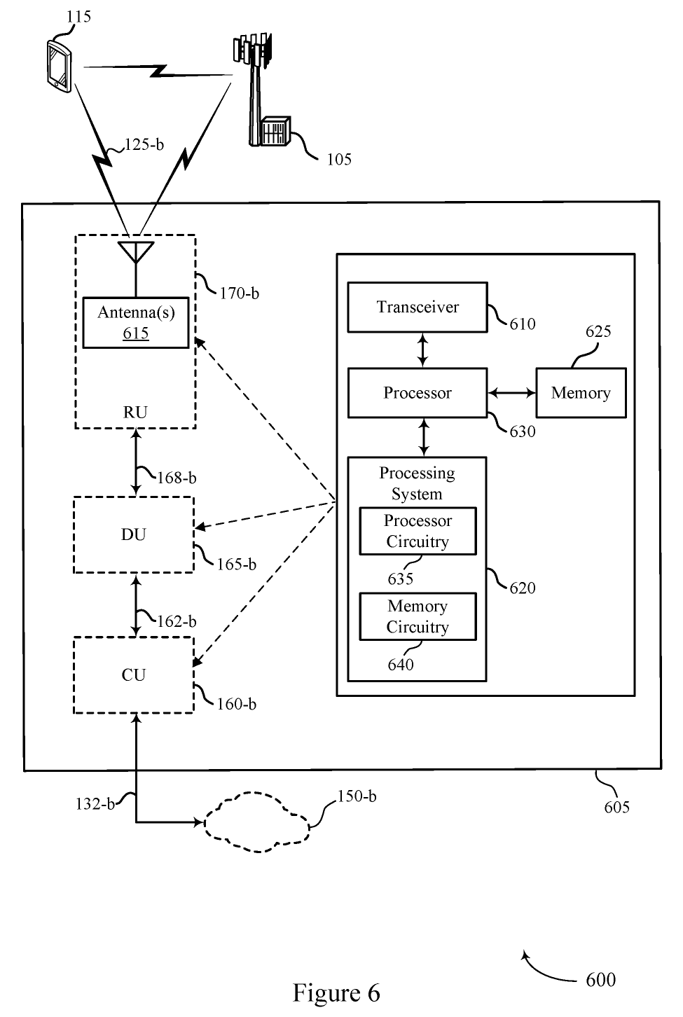

FIG. 6 shows an example of a system 600 including a device 605 that supports techniques for UE memory management in wireless communications. The device 605 may communicate (such as via one or more wired interfaces or one or more wireless interfaces) with other network devices or network equipment such as a core network 150-b, other network entities 105, UEs 115, or any combination thereof. The device 605 may include components for transmitting and receiving communication, which may include a processing system 620, a transceiver 610, antenna(s) 615, a memory 625, and a processor 630. Components of the device 605 may be coupled (such as operatively, communicatively, functionally, electronically, electrically, in electronic communication) via one or more interfaces.

The transceiver 610 may communicate bi-directionally with another transceiver via wired or wireless links, and may support transmission operations, reception operations, or both, as described herein. The transceiver 610 may include a modem to modulate and demodulate signals, to provide the modulated signals for transmission (such as via antenna(s) 615, via a wired interface), and to demodulate received signals (such as received via antenna(s) 615, received via a wired interface). The transceiver 610 may be operable to support communication via one or more communication links (such as a communication link 125-b, a backhaul link 132-b, a midhaul link 162-b, fronthaul link 168-b).

The processor 630 may be a general-purpose processing component that supports various operations (such as applications) of the device 605. The memory 625 may be a general-purpose storage component that stores code executable by the processor 630. Such code may include instructions that, when executed by the processor 630, cause the device 605 to perform various functions (such as to support an application of the device 605).

For examples in which the device 605 is a network entity 105 in a disaggregated architecture, one or more components of the device 605 may be located at one or more of a CU 160-b, a DU 165-b, or an RU 170-b, one or more of which may include aspects of the processing system 620, the processor 630, the memory 625, or the transceiver 610. Functions of the device 605 may be performed at different components or an operation may be divided between different components (such as different functions being supported by aspects of the CU 160-b, the DU 165-b, or the RU 170-b, the transceiver 610, the processor 630, the memory 625, the processing system 620, or any combination thereof). For example, the processing system 620 may be a component of one or more of the CU 160-b, the DU 165-b, or the RU 170-b. In some examples, interfaces between components of device 605 (such as CU 160-b, DU 165-b, RU 170-b) may support communication at a protocol layer or between protocol layers of a protocol stack.

In some examples, the processing system 620 may manage aspects of communication with the core network 150-b (such as via a backhaul link 132). For example, the processing system 620 may manage the transfer of data communication for UEs 115 with a gateway of the core network 150-b. In some examples, the processing system 620 may manage communication with one or more other network entities 105 and may include a controller or scheduler for controlling communication with UEs 115 (such as in cooperation with the one or more other network entities 105). In some examples, the processing system 620 may support an interface (such as X2 interface, Xn interface) to provide communication between network entities 105.

The processing system 620 may be an example of a processing system 145 or a processing system 420. For example, the processing system 620 may include processor circuitry 635 and memory circuitry 640 that stores code, and the processing system 620 may be configured to cause the device 605 to perform operations that support techniques for UE memory management in wireless communications. Although the processing system 620 is illustrated as a separate component, which may involve a separate chip, chipset, or other module, in some implementations, one or more functions described with reference to the processing system 620 may be supported by or performed by a transceiver 610, antenna(s) 615, a processor 630, memory 625, or any combination thereof, such that a processing system 620 may include one or more of a transceiver 610, antenna(s) 615, a processor 630, memory 625, or any combination thereof. Further, processor circuitry 635 and memory circuitry 640 each may be implemented at the device 605 in accordance with an aggregated architecture, or the processor circuitry 635 and the memory circuitry 640 may be implemented at one or more of a CU 160-b, a DU 165-b, or an RU 170-b in accordance with a disaggregated architecture.

By including or configuring the processing system 620 for operation in the device 605 as described herein, may support techniques for indications of a UE memory capability or status, which may allow a UE to store information, and then retrieve and apply such information through an indication from another wireless device (e.g., a proactive indication), which may reduce latency associated with retrieval or application of the information.

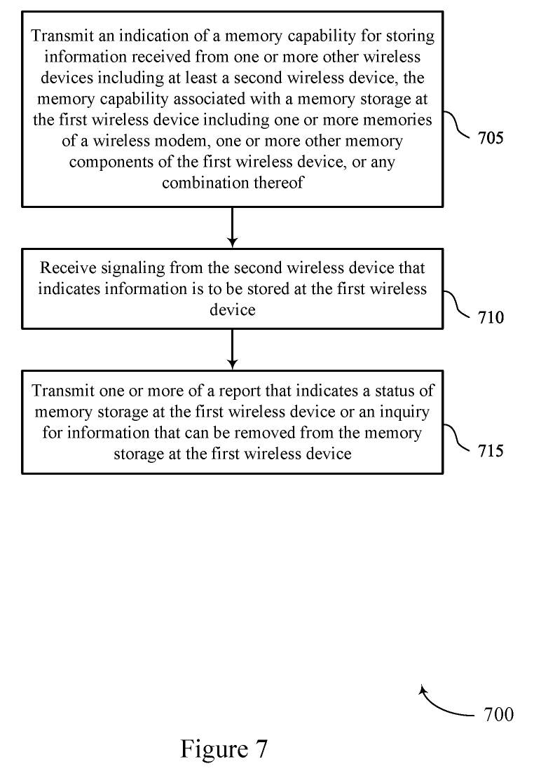

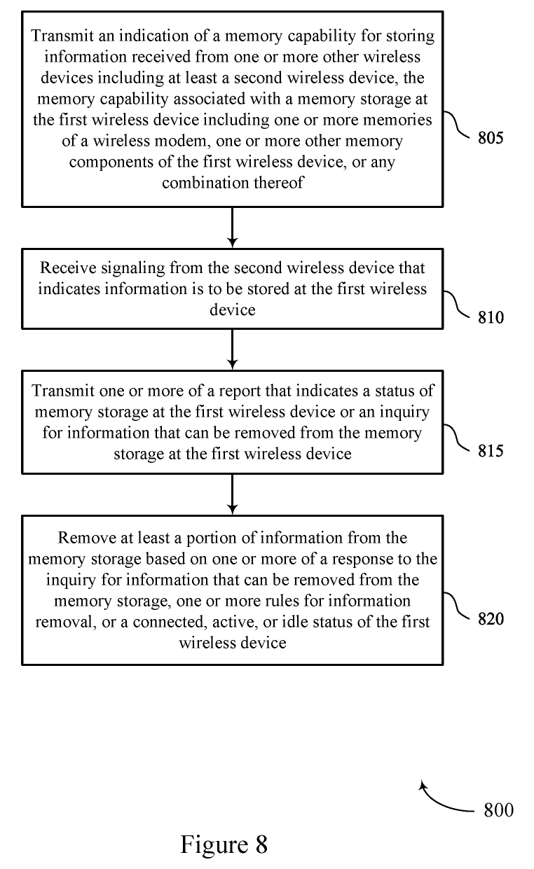

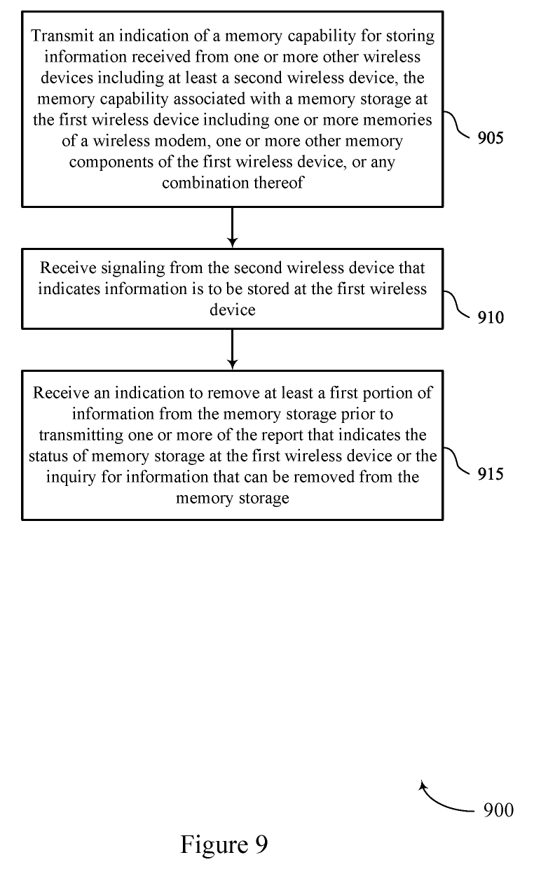

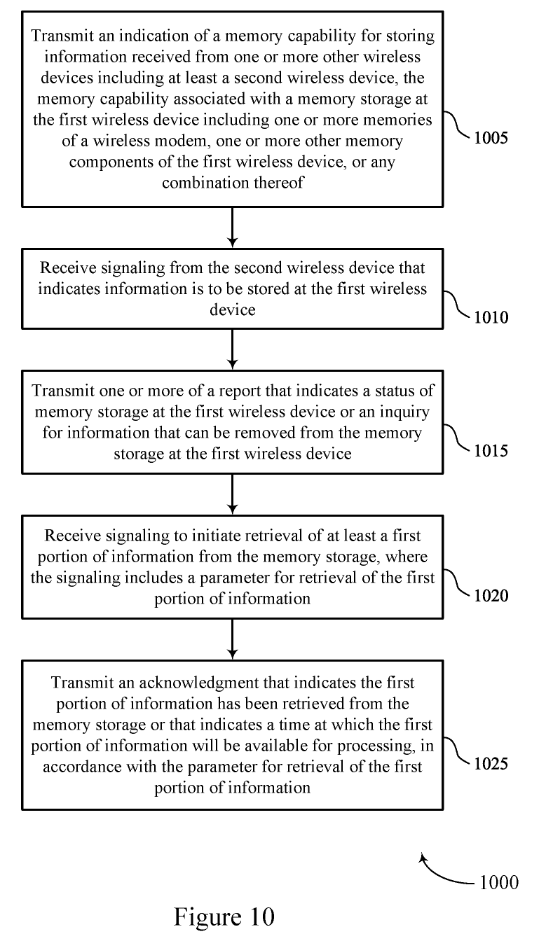

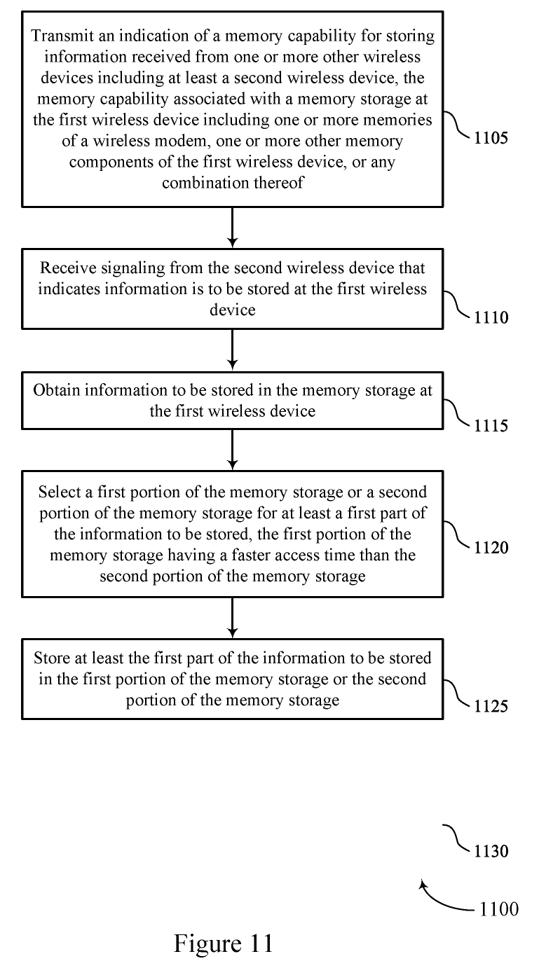

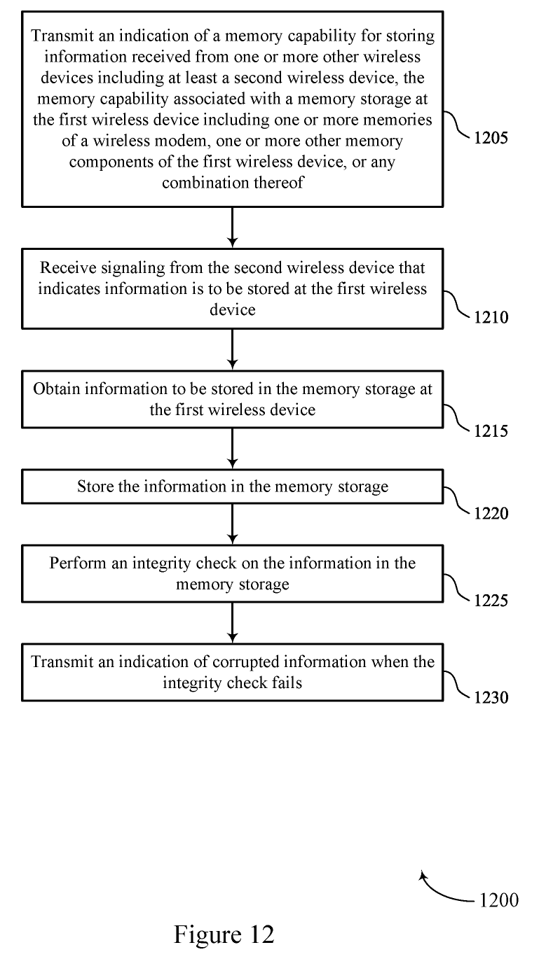

FIG. 7 shows an example of a method 700 that supports techniques for UE memory management in wireless communications. Operations of the method 700 may be performed by a UE 115 or a network entity 105 or respective components (such as using a processing system configured to cause the respective device to perform one or more of the operations), as described herein.

At 705, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 705 may be performed by a memory capability component 425.

At 710, the method may include receiving signaling from the second wireless device that indicates information is to be stored at the first wireless device. In some examples, aspects of the operations of 710 may be performed by a memory storage component 430.

At 715, the method may include transmitting one or more of a report that indicates a status of memory storage at the first wireless device or an inquiry for information that can be removed from the memory storage at the first wireless device. In some examples, aspects of the operations of 715 may be performed by a memory management component 435.

FIG. 8 shows an example of a method 800 that supports techniques for UE memory management in wireless communications. Operations of the method 800 may be performed by a UE 115 or a network entity 105 or respective components (such as using a processing system configured to cause the respective device to perform one or more of the operations), as described herein.

At 805, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 805 may be performed by a memory capability component 425.

At 810, the method may include receiving signaling from the second wireless device that indicates information is to be stored at the first wireless device. In some examples, aspects of the operations of 810 may be performed by a memory storage component 430.

At 815, the method may include transmitting one or more of a report that indicates a status of memory storage at the first wireless device or an inquiry for information that can be removed from the memory storage at the first wireless device. In some examples, aspects of the operations of 815 may be performed by a memory management component 435.

At 820, the method may include removing at least a portion of information from the memory storage based on one or more of a response to the inquiry for information that can be removed from the memory storage, one or more rules for information removal, or a connected, active, or idle status of the first wireless device. In some examples, aspects of the operations of 820 may be performed by a memory management component 435.

FIG. 9 shows an example of a method 900 that supports techniques for UE memory management in wireless communications. Operations of the method 900 may be performed by a UE 115 or a network entity 105 or respective components (such as using a processing system configured to cause the respective device to perform one or more of the operations), as described herein.

At 905, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 905 may be performed by a memory capability component 425.

At 910, the method may include receiving signaling from the second wireless device that indicates information is to be stored at the first wireless device. In some examples, aspects of the operations of 910 may be performed by a memory storage component 430.

At 915, the method may include receiving an indication to remove at least a first portion of information from the memory storage prior to transmitting one or more of the report that indicates the status of memory storage at the first wireless device or the inquiry for information that can be removed from the memory storage. In some examples, aspects of the operations of 915 may be performed by a memory management component 435.

FIG. 10 shows an example of a method 1000 that supports techniques for UE memory management in wireless communications. Operations of the method 1000 may be performed by a UE 115 or a network entity 105 or respective components (such as using a processing system configured to cause the respective device to perform one or more of the operations), as described herein.

At 1005, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 1005 may be performed by a memory capability component 425.

At 1010, the method may include receiving signaling from the second wireless device that indicates information is to be stored at the first wireless device. In some examples, aspects of the operations of 1010 may be performed by a memory storage component 430.

At 1015, the method may include transmitting one or more of a report that indicates a status of memory storage at the first wireless device or an inquiry for information that can be removed from the memory storage at the first wireless device. In some examples, aspects of the operations of 1015 may be performed by a memory management component 435.

At 1020, the method may include receiving signaling to initiate retrieval of at least a first portion of information from the memory storage, where the signaling includes a parameter for retrieval of the first portion of information. In some examples, aspects of the operations of 1020 may be performed by an information retrieval component 440.

At 1025, the method may include transmitting an acknowledgment that indicates the first portion of information has been retrieved from the memory storage or that indicates a time at which the first portion of information will be available for processing, in accordance with the parameter for retrieval of the first portion of information. In some examples, aspects of the operations of 1025 may be performed by an information retrieval component 440.

FIG. 11 shows an example of a method 1100 that supports techniques for UE memory management in wireless communications. Operations of the method 1100 may be performed by a UE 115 or a network entity 105 or respective components (such as using a processing system configured to cause the respective device to perform one or more of the operations), as described herein.

At 1105, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 1105 may be performed by a memory capability component 425.

At 1110, the method may include receiving signaling from the second wireless device that indicates information is to be stored at the first wireless device. In some examples, aspects of the operations of 1110 may be performed by a memory storage component 430.

At 1115, the method may include obtaining information to be stored in the memory storage at the first wireless device. In some examples, aspects of the operations of 1115 may be performed by a memory management component 435.

At 1120, the method may include selecting a first portion of the memory storage or a second portion of the memory storage for at least a first part of the information to be stored, the first portion of the memory storage having a faster access time than the second portion of the memory storage. In some examples, aspects of the operations of 1120 may be performed by a memory management component 435.

At 1125, the method may include storing at least the first part of the information to be stored in the first portion of the memory storage or the second portion of the memory storage. In some examples, aspects of the operations of 1125 may be performed by a memory management component 435.

FIG. 12 shows an example of a method 1200 that supports techniques for UE memory management in wireless communications. Operations of the method 1200 may be performed by a UE 115 or a network entity 105 or respective components (such as using a processing system configured to cause the respective device to perform one or more of the operations), as described herein.

At 1205, the method may include transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof. In some examples, aspects of the operations of 1205 may be performed by a memory capability component 425.

At 1210, the method may include receiving signaling from the second wireless device that indicates information is to be stored at the first wireless device. In some examples, aspects of the operations of 1210 may be performed by a memory storage component 430.

At 1215, the method may include obtaining information to be stored in the memory storage at the first wireless device. In some examples, aspects of the operations of 1215 may be performed by an information storage component 445.

At 1220, the method may include storing the information in the memory storage. In some examples, aspects of the operations of 1220 may be performed by an information storage component 445.

At 1225, the method may include performing an integrity check on the information in the memory storage. In some examples, aspects of the operations of 1225 may be performed by an information storage component 445.

At 1230, the method may include transmitting an indication of corrupted information when the integrity check fails. In some examples, aspects of the operations of 1230 may be performed by an information storage component 445.

Implementation examples are described in the following numbered clauses:
Aspect 1: A method for wireless communications at a first wireless device, comprising: transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof; receiving signaling from the second wireless device that indicates information is to be stored at the first wireless device; and transmitting one or more of a report that indicates a status of memory storage at the first wireless device or an inquiry for information that can be removed from the memory storage at the first wireless device.
Aspect 2: The method of aspect 1, wherein the information stored at the first wireless device includes one or more RRC profiles, one or more artificial intelligence of machine learning models, one or more measurements obtained at the first wireless device, one or more configurations for wireless communications at the first wireless device, relay information for relaying information between the second wireless device and one or more other wireless devices, sensing information, memory-as-a-service information, digital twin information or any combination thereof.
Aspect 3: The method of any of aspects 1 through 2, wherein the indication of the memory capability includes one or more amounts of storage available for storing information received from one or more other wireless devices, one or more amounts of storage available for storing one or more types of information, or any combination thereof.
Aspect 4: The method of any of aspects 1 through 3, wherein the signaling from the second wireless device indicates two or more partitions for the memory storage at the first wireless device for two or more different types of information.
Aspect 5: The method of any of aspects 1 through 4, wherein the indication of the memory capability is transmitted based on a schedule or with a memory status report that is periodic, event-triggered, or requested by the second wireless device.
Aspect 6: The method of any of aspects 1 through 5, wherein the indication of the memory capability includes a quantity of bytes available for storage for one or more types of data, an indication of a percentage of a total storage capacity that is available for one or more types of data, or an indication of a quantized range of available storage capacity for the one or more types of information.
Aspect 7: The method of any of aspects 1 through 6, wherein the inquiry for information that can be removed is transmitted responsive a remaining quantity of bytes available for storage being less than a threshold value or less than a quantity of storage associated with an upcoming action.
Aspect 8: The method of aspect 7, wherein the inquiry for information that can be removed includes a list of indicators of stored information that are candidates for removal.
Aspect 9: The method of any of aspects 1 through 8, further comprising: transmitting, responsive to removing at least a portion of stored information, a report of removed information, wherein the removed information is identified based at least in part on a response from the second wireless device that indicates information to be removed, one or more rules for identifying information to be removed, or any combination thereof.
Aspect 10: The method of any of aspects 1 through 9, wherein the indication of the memory capability includes one or more of a quantity of information that can be stored at the first wireless device, a per-item size limit for information to be stored, a retrieval time or latency for stored information, a time duration for storing information, a validity time duration for stored information, one or more time periods during which storage is available, retrieval time as a function of an amount of information stored at the memory storage at the first wireless device, or any combination thereof.
Aspect 11: The method of aspect 10, wherein the indication of the memory capability is provided for two or more different configurations of the first wireless device, each configuration based at least in part on a state of the first wireless device, a type of information that is stored, or both, and wherein the state of the first wireless device is an idle-mode state, an inactive-mode state, or a connected-mode state.
Aspect 12: The method of any of aspects 1 through 11, wherein the report is transmitted according to a periodic schedule or detection of a trigger event.
Aspect 13: The method of any of aspects 1 through 12, further comprising: receiving a request for one or more of an indication of whether storage is available, an indication of whether a particular type or size of information can be stored, or an indication of whether a certain quantity of information can be stored, and wherein the report is transmitted responsive to the request.
Aspect 14: The method of any of aspects 1 through 13, further comprising: removing at least a portion of information from the memory storage based at least in part on one or more of a response to the inquiry for information that can be removed from the memory storage, one or more rules for information removal, or a connected, active, or idle status of the first wireless device.
Aspect 15: The method of any of aspects 1 through 14, further comprising: receiving an indication to remove at least a first portion of information from the memory storage prior to transmitting one or more of the report that indicates the status of memory storage at the first wireless device or the inquiry for information that can be removed from the memory storage.
Aspect 16: The method of any of aspects 1 through 15, further comprising: receiving signaling to initiate retrieval of at least a first portion of information from the memory storage, wherein the signaling includes a parameter for retrieval of the first portion of information; and transmitting an acknowledgment that indicates the first portion of information has been retrieved from the memory storage or that indicates a time at which the first portion of information will be available for processing, in accordance with the parameter for retrieval of the first portion of information.
Aspect 17: The method of aspect 16, wherein the parameter for retrieval of the first portion of information includes one or more conditions to trigger the retrieval of the first portion of information.
Aspect 18: The method of any of aspects 16 through 17, wherein the acknowledgment is transmitted when the first wireless device is able to support retrieval of the first portion of information in accordance with the parameter, and wherein a negative acknowledgment is transmitted otherwise.
Aspect 19: The method of any of aspects 1 through 18, wherein the report that indicates the status of memory storage includes one or more memory access speeds of one or more portions of the memory storage, an indication of information that has been retrieved from the memory storage, a time for accessing one or more portions of stored information, or any combination thereof.
Aspect 20: The method of any of aspects 1 through 19, further comprising: obtaining information to be stored in the memory storage at the first wireless device; selecting a first portion of the memory storage or a second portion of the memory storage for at least a first part of the information to be stored, the first portion of the memory storage having a faster access time than the second portion of the memory storage; and storing at least the first part of the information to be stored in the first portion of the memory storage or the second portion of the memory storage.
Aspect 21: The method of any of aspects 1 through 20, wherein the first wireless device is a first UE or a first network entity, and the second wireless device is a second UE or a second network entity.
Aspect 22: The method of any of aspects 1 through 21, further comprising: receiving information to be stored from the second wireless device, wherein the first wireless device and the second wireless device provide assistance to each other for storing or retrieving information pertaining to one or more RRC profiles, one or more artificial intelligence of machine learning models, one or more measurements obtained at the first wireless device or the second wireless device, one or more configurations for wireless communications at the first wireless device or the second wireless device, relay information for relaying information between the second wireless device and one or more other wireless devices, sensing information, memory-as-a-service information, digital twin information or any combination thereof.
Aspect 23: The method of aspect 22, wherein the first wireless device has one or more of a first memory configuration for local storage of the first wireless device, or a second memory configuration for storage of information from one or more other wireless devices.
Aspect 24: The method of any of aspects 1 through 23, wherein the first wireless device and the second wireless device communicate via one or more medium access control (MAC) control elements, control channel transmissions, unicast transmissions, broadcast transmissions, multicast transmissions, paging messages, RRC signaling, or any combinations thereof.
Aspect 25: The method of any of aspects 1 through 24, further comprising: receiving a request to reserve at least a portion of the memory storage for storing information in accordance with signaling from the second wireless device, and wherein the indication of the memory capability further indicates whether at least the portion of the memory storage is available for storing information.
Aspect 26: The method of any of aspects 1 through 25, further comprising: exchanging signaling with the second wireless device to coordinate a resolution or a quality of the information, or both, to be stored at the first wireless device.
Aspect 27: The method of any of aspects 1 through 26, further comprising: transmitting a message to the second wireless device that indicates a cause of unavailability of the memory storage at the first wireless device for further storage.
Aspect 28: The method of any of aspects 1 through 27, further comprising: obtaining information to be stored in the memory storage at the first wireless device; storing the information in the memory storage; performing an integrity check on the information in the memory storage; and transmitting an indication of corrupted information when the integrity check fails.
Aspect 29: The method of any of aspects 1 through 28, wherein the memory storage at the first wireless device is associated with one or more components, and an amount of storage, retrieval times for obtaining stored information, or both are reported to the second wireless device based at least in part on the one or more components that provide the memory storage.
Aspect 30: The method of any of aspects 1 through 29, wherein the indication of the memory capability indicates that the first wireless device supports one or more memory-related triggering conditions to take one or more actions, wherein the one or more memory-related triggering conditions include one or more of reading or writing latency, or one or more defined conditions for a use case, feature, model, or profile, and wherein the one or more actions include one or more of removing fetching, caching, collecting, downloading, or logging information.
Aspect 31: A first wireless device for wireless communications, comprising a processing system that includes processor circuitry and memory circuitry that stores code, the processing system configured to cause the first wireless device to perform a method of any of aspects 1 through 30.
Aspect 32: A first wireless device for wireless communications, comprising at least one means for performing a method of any of aspects 1 through 30.
Aspect 33: A non-transitory computer-readable medium storing code for wireless communications, the code comprising instructions executable by one or more processors to perform a method of any of aspects 1 through 30.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
a processing system that includes processor circuitry and memory circuitry that stores code, the processing system configured to cause the first wireless device to:
transmit an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof;
receive signaling from the second wireless device that indicates information is to be stored at the first wireless device; and
transmit one or more of a report that indicates a status of memory storage at the first wireless device or an inquiry for information that can be removed from the memory storage at the first wireless device.

2. The first wireless device of claim 1, wherein the information stored at the first wireless device includes one or more radio resource control (RRC) profiles, one or more artificial intelligence of machine learning models, one or more measurements obtained at the first wireless device, one or more configurations for wireless communications at the first wireless device, relay information for relaying information between the second wireless device and one or more other wireless devices, sensing information, memory-as-a-service information, digital twin information or any combination thereof.

3. The first wireless device of claim 1, wherein the indication of the memory capability includes one or more amounts of storage available for storing information received from one or more other wireless devices, one or more amounts of storage available for storing one or more types of information, or any combination thereof.

4. The first wireless device of claim 1, wherein the signaling from the second wireless device indicates two or more partitions for the memory storage at the first wireless device for two or more different types of information.

5. The first wireless device of claim 1, wherein the indication of the memory capability is transmitted based on a schedule or with a memory status report that is periodic, event-triggered, or requested by the second wireless device.

6. The first wireless device of claim 1, wherein the indication of the memory capability includes a quantity of bytes available for storage for one or more types of data, an indication of a percentage of a total storage capacity that is available for one or more types of data, or an indication of a quantized range of available storage capacity for the one or more types of information.

7. The first wireless device of claim 1, wherein the inquiry for information that can be removed is transmitted responsive to a remaining quantity of bytes available for storage being less than a threshold value or less than a quantity of storage associated with an upcoming action.

8. The first wireless device of claim 7, wherein the inquiry for information that can be removed includes a list of indicators of stored information that are candidates for removal.

9. The first wireless device of claim 1, wherein the processing system is further configured to cause the first wireless device to:
transmit, responsive to removing at least a portion of stored information, a report of removed information, wherein the removed information is identified based at least in part on a response from the second wireless device that indicates information to be removed, one or more rules for identifying information to be removed, or any combination thereof.

10. The first wireless device of claim 1, wherein the indication of the memory capability includes one or more of a quantity of information that can be stored at the first wireless device, a per-item size limit for information to be stored, a retrieval time or latency for stored information, a time duration for storing information, a validity time duration for stored information, one or more time periods during which storage is available, retrieval time as a function of an amount of information stored at the memory storage at the first wireless device, or any combination thereof.

11. The first wireless device of claim 10, wherein the indication of the memory capability is provided for two or more different configurations of the first wireless device, each configuration based at least in part on a state of the first wireless device, a type of information that is stored, or both, and wherein the state of the first wireless device is an idle-mode state, an inactive-mode state, or a connected-mode state.

12. The first wireless device of claim 1, wherein the report is transmitted according to a periodic schedule or detection of a trigger event.

13. The first wireless device of claim 1, wherein the processing system is further configured to cause the first wireless device to:
receive a request for one or more of an indication of whether storage is available, an indication of whether a particular type or size of information can be stored, or an indication of whether a certain quantity of information can be stored, and wherein the report is transmitted responsive to the request.

14. The first wireless device of claim 1, wherein the processing system is further configured to cause the first wireless device to:
remove at least a portion of information from the memory storage based at least in part on one or more of a response to the inquiry for information that can be removed from the memory storage, one or more rules for information removal, or a connected, active, or idle status of the first wireless device.

15. The first wireless device of claim 1, wherein the processing system is further configured to cause the first wireless device to:
receive an indication to remove at least a first portion of information from the memory storage prior to transmitting one or more of the report that indicates the status of memory storage at the first wireless device or the inquiry for information that can be removed from the memory storage.

16. The first wireless device of claim 1, wherein the processing system is further configured to cause the first wireless device to:
receive signaling to initiate retrieval of at least a first portion of information from the memory storage, wherein the signaling includes a parameter for retrieval of the first portion of information; and
transmit an acknowledgment that indicates the first portion of information has been retrieved from the memory storage or that indicates a time at which the first portion of information will be available for processing, in accordance with the parameter for retrieval of the first portion of information.

17. The first wireless device of claim 16, wherein the parameter for retrieval of the first portion of information includes one or more conditions to trigger the retrieval of the first portion of information.

18. The first wireless device of claim 16, wherein the acknowledgment is transmitted when the first wireless device is able to support retrieval of the first portion of information in accordance with the parameter, and wherein a negative acknowledgment is transmitted otherwise.

19. A method for wireless communications at a first wireless device, comprising:
transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof;
receiving signaling from the second wireless device that indicates information is to be stored at the first wireless device; and
transmitting one or more of a report that indicates a status of memory storage at the first wireless device or an inquiry for information that can be removed from the memory storage at the first wireless device.

20. A first wireless device for wireless communications, comprising:
means for transmitting an indication of a memory capability for storing information received from one or more other wireless devices including at least a second wireless device, the memory capability associated with a memory storage at the first wireless device including one or more memories of a wireless modem, one or more other memory components of the first wireless device, or any combination thereof;
means for receiving signaling from the second wireless device that indicates information is to be stored at the first wireless device; and
means for transmitting one or more of a report that indicates a status of memory storage at the first wireless device or an inquiry for information that can be removed from the memory storage at the first wireless device.
